(19) United States
(12) Patent Application Publication
(10) Pub. No.: US 2021/0349862 A1
(43) Pub. Date: Nov. 11, 2021

(54) DATA ANALYSIS SYSTEM AND DATA ANALYSIS METHOD

(71) Applicant: Delta Electronics, Inc., Taoyuan City (TW)

(72) Inventors: Chih-Chieh SHAO, Taoyuan City (TW); Zheng-Bang LIU, Taoyuan City (TW); Ju-Hsin KUNG, Taoyuan City (TW)

(21) Appl. No.: 16/933,208

(22) Filed: Jul. 20, 2020

(30) Foreign Application Priority Data
May 8, 2020 (CN) 202010382199.4

(51) Int. Cl. G06F 16/21; G06F 16/28; G06F 16/215; G06F 16/26

(52) U.S. Cl. CPC G06F 16/212; G06F 16/285; G06F 16/288; G06F 16/26; G06F 16/215

(57) ABSTRACT

A data analysis method includes steps of: obtaining at least one data table; wherein the data table includes a plurality of fields, and each of the fields stores field data; analyzing the field type according to the field data; determining a field category for each of the fields; calculating the similarity between the fields in different tables; determining the correlation between each of the fields according to the similarity; generating a field data description file according to the field type, the field categories and the correlations; and determining whether the field data description file is abnormal. A data analysis system is also disclosed.

### CROSS REFERENCE TO RELATED APPLICATIONS

This application claims priority of China Patent Application No. 202010382199.4, filed on May 8, 2020, the entirety of which is incorporated by reference herein.

### BACKGROUND OF THE INVENTION

### Field of the Invention

The present disclosure relates to an analysis method and, in particular to a data analysis system and data analysis method.

### Description of the Related Art

As data collection has become more convenient, the amount of available data has increased rapidly, and data analysis technology is also booming. Effective big data analysis results depend on good data quality, so data quality is an important issue in data analysis. There are currently two types of data quality diagnosis methods: data analysis experts using program language analysis themselves, or using analysis software packages that are available on the consumer market.

However, in the data analysis process, the quality of the data and pre-process the data must be confirmed firstly. However, in practice, the quality of data is often observed in the data pre-processing stage, which requires that a lot of manpower be invested in this stage, resulting in huge communication and time costs.

Therefore, how to establish an automated auxiliary mechanism to reduce the human resources and time costs required in the data pre-processing stage has become one of the problems to be solved in the field.

### BRIEF SUMMARY OF THE INVENTION

In accordance with one feature of the present invention, the present disclosure provides a data analysis system. The data analysis system includes a processor, a storage device, a field-type analysis device, a field category device and a field correlation device. The processor is configured to obtain at least one data table, wherein the data table includes a plurality of fields, and each of the fields stores field data. The storage device is configured to store the data table. A field-type analysis device is configured to analyze the field type based on the field data. A field category device is configured to determine a field category for each of the fields. The field correlation device is configured to calculate the similarity between the fields in different tables, and determine a correlation between each of the fields according to the similarity. Moreover, the processor generates a field data description file according to the field type, the field categories and the correlations, and the processor determines whether the field data description file is abnormal.

In accordance with one feature of the present invention, the present disclosure provides a data analysis method includes the following steps: obtaining at least one data table; wherein the data table includes a plurality of fields, each of the fields stores field data; analyzing the field type according to the field data; determining a field category for each of the fields; and calculating the similarity between the fields in different tables, and determining a correlation between each of the fields according to the similarity, generating a field data description file according to the field type, the field categories and the correlations, and determining whether the field data description file is abnormal.

According to the data analysis method and data analysis system proposed by the present invention, it is possible to automatically establish an automated mechanism by analyzing information such as field type, field category, correlation, etc. at the stage of data pre-processing. In this way, the data description file of the field is generated to assist the user to quickly understand the data. The data analysis method and data analysis system can reduce the manpower required in the data pre-processing stage and improve the data analysis efficiency in the data pre-processing stage.

### BRIEF DESCRIPTION OF THE DRAWINGS

The invention can be more fully understood by reading the subsequent detailed description and examples with references made to the accompanying drawings, wherein:

FIG. 1 is a block diagram of a data analysis system in accordance with one embodiment of the present disclosure.

FIG. 2 is a block diagram of a data analysis method in accordance with one embodiment of the present disclosure.

FIGS. 3A-3B are flowcharts of a field-type analysis method in accordance with one embodiment of the present disclosure.

FIG. 4 is a flowchart of a field category method in accordance with one embodiment of the present disclosure.

FIG. 5 is a flowchart of a field correlation method in accordance with one embodiment of the present disclosure.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The present invention will be described with respect to particular embodiments and with reference to certain drawings, but the invention is not limited thereto and is only limited by the claims. It will be further understood that the terms “comprises,” “comprising,” “comprises” and/or “including,” when used herein, specify the presence of stated features, integers, steps, operations, elements, and/or components, but do not preclude the presence or addition of one or more other features, integers, steps, operations, elements, components, and/or groups thereof.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

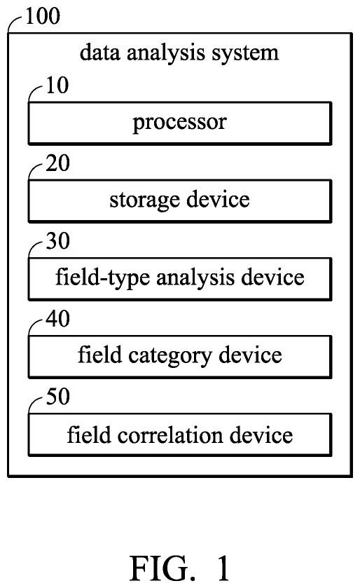

FIG. 1 is a block diagram of a data analysis system 100 in accordance with one embodiment of the present disclosure. As shown in FIG. 1, the data analysis system 100 may include a processor 10, a storage device 20, a field-type analysis device 30, a field category device 40 and a field correlation device 50. It is important to note here that the block diagram shown in FIG. 1 is only for the convenience of describing the embodiments of the present invention. However, the present invention is not limited to FIG. 1, and the data analysis system 100 may also include other components.

In one embodiment, the processer 10 can be any electronic device having a calculation function. The processer 10 can be implemented using an integrated circuit, such as a microcontroller, a microprocessor, a digital signal processor, an application specific integrated circuit (ASIC), or a logic circuit.

In one embodiment, the field-type analysis device 30, the field category device 40 and the field correlation device 50 can be implemented individually or in combination as, for example, a microcontroller or a microprocessor, digital signal processor, ASIC or a logic circuit.

In one embodiment, the field-type analysis device 30, the field category device 40 and the field correlation device 50 can be software running on electronic devices (for example, including circuits, processors, or logic circuits).

In one embodiment, the storage device 20 can be implemented as a read-only memory, a flash memory, a floppy disk, a hard disk, a compact disk, a flash drive, a tape, a network accessible database, or as a storage medium that can be easily considered by those skilled in the art to have the same function. The storage device 20 can be used to store one or more tables.

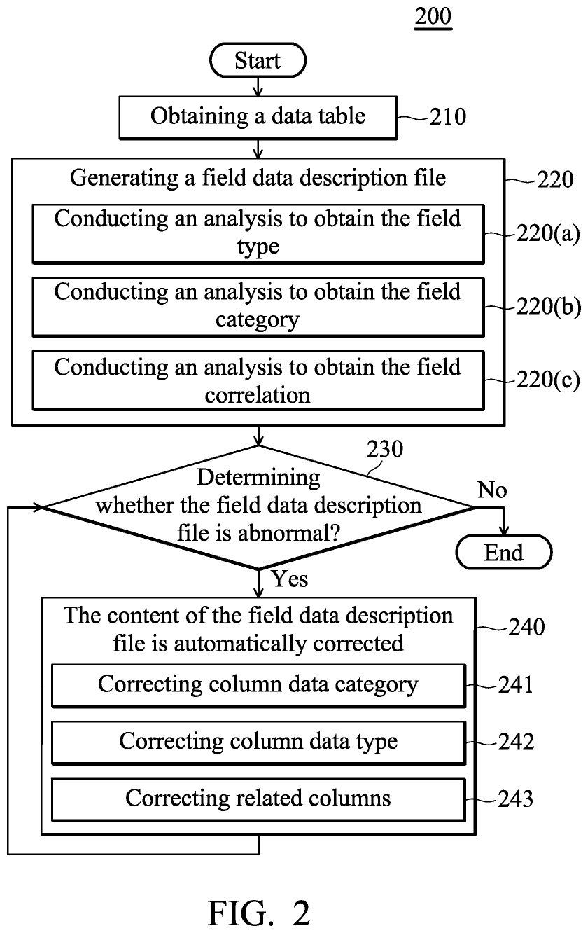

FIG. 2 is a block diagram of a data analysis method 200 in accordance with one embodiment of the present disclosure. The data analysis method 200 of FIG. 2 can be implemented by the data analysis system 100 of FIG. 1.

In step 210, the processor 10 obtains a data table.

In one embodiment, the data table includes multiple fields, and each field stores field data. For example, the data table includes machine model field, machine identification (ID) field, machine multiplex field, manufacturing time field, shipping time field, etc. Moreover, different data is stored in these fields, for example, the machine model field stores “NB1” (this is a string), the machine identification field stores “3” (this is an integer), and the machine multiplex field stores “0” (this is the Boolean value), the manufacturing time field stores “2020/03/16” (this is the date), and the shipping time field stores “2020/09/16” (this is the date). However, this is only an example, and the field and field data of the present invention are not limited thereto.

In an embodiment, the processor 10 can obtain multiple data tables.

In step 220, the processor 10 triggers the field-type analysis device 30, the field category device 40, and the field correlation device 50 to generate a field data description file.

In one embodiment, step 220 includes any one or a combination of multiple sub-steps 220(a) to 220(c). In sub-step 220(a), the processor 10 conducts an analysis to obtain the field type. In sub-step 220(b), the processor 10 conducts an analysis to obtain the field category, and in sub-step 220(c), the processor 10 conducts an analysis to obtain the field correlation.

In one embodiment, the field-type analysis device 30 analyzes the field type based on the field data. The field type refers to the data type of the content stored in each field (for example, 500 data in a row). The data type is, for example, a numeric value, string, time type, or Boolean value. In one field, the data type that accounts for most of the type of the total data is regarded as the main type of the field. For example, if there are 500 records in a field in the data table, of which 499 are numeric values, then this field is defined as the numeric value field type.

In one embodiment, the field category device 40 determines the field category for each of these fields. The field category refers to the category to which the field name belongs. Examples include people, machines, materials, methods, measurement, and so on. For example, if the keyword “machine” is included in the field name, the field category is classified as the machine category field.

In an embodiment, the field correlation device 50 calculates the similarity between two columns of different data tables (cross-data tables). The field correlation device 50 determines whether a correlation between the fields exists according to the similarities. Similarity refers to the degree of correlation between at least two fields in the cross-table. For example, the manufacturing time field in the product manufacturing table and the shipping time field in the product shipping table, these two fields from different data tables are related in time.

In one embodiment, the processor 10 generates a field data description file according to the field types, field categories, and the correlations, and then determines whether the field data description file is abnormal.

In one embodiment, the field data description file includes the information such field categories, field types, field correlations, etc.

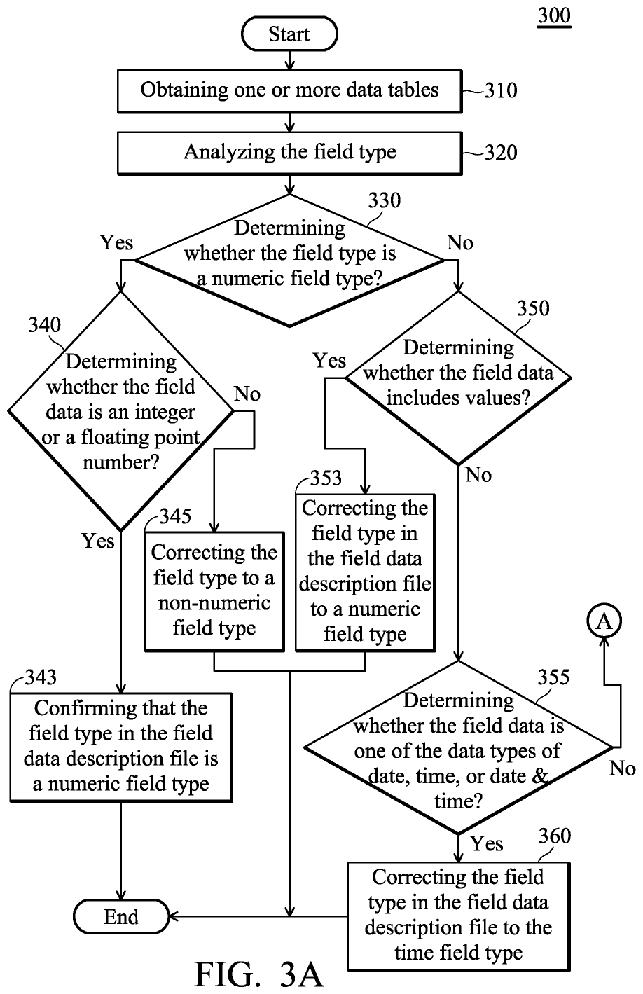

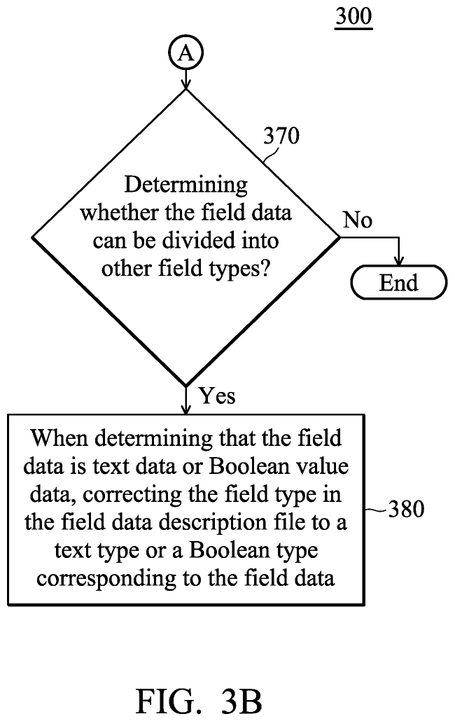

The detailed flow of the field-type analysis device 30, the field category device 40, and the field correlation device 50 will be described correspondingly in the subsequent FIGS. 3 to 5.

In step 230, the processor 10 determines whether the field data description file is abnormal. In one embodiment, the processor 10 determines whether the field data description file is complete or correct. In one embodiment, if the processor 10 determines that the field data description file is incomplete or incorrect, step 240 is performed. If the processor 10 determines that the field data description file is complete and correct, the process ends.

In one embodiment, the field data description file may be determined to be abnormal when the field data description file is incomplete, or when there is an error in the field data description file.

For example, there are 500 data in a field in the data table, 499 of the field data are numeric values, and 1 is a string. This field should be defined as a numeric field type. If the field-type analysis device 30 analyzes the field type to other field types (such as string, Boolean value, time), the processor 10 determines that the field data description file is abnormal, and step 240 is performed.

For example, there are 500 data in a field in the data table, 499 of the field data are numeric values, and 1 is blank data. If the field-type analysis device 30 fails to analyze the field type due to blank data, the processor 10 determines that the field data description file is incomplete or incorrect, and step 240 is performed.

In step 240, when the processor 10 determines that the field data description file is abnormal, the content of the field data description file is automatically corrected.

In one embodiment, the processor 10 calculates the missing data from the storage device 20 based on the missing part in the field data description file to automatically correct the content in the field data description file. For example, step 240 includes sub-steps 241-243: correcting column data category 241, correcting column data type 242 and/or correcting related columns 243 in other data tables.

In one embodiment, the user can input the content of the new data description file based on the missing part of the data description file. For example, the user inputs the newly added or updated data based on the missing part of the description file through an input device (e.g., mouse cursor, touch screen, and keyboard). After the processor 10 receives the newly added or updated data from the input device, the processor 10 completes the content in the field data description file through the newly added or updated data. For example, the automatic correction comprises: adding the field data description or updating the field data description; adding the amount of field data groups or updating the amount of field data groups; adding the field or updating the field to allow the nullification, addition to, or updating of the field-data value range; allowing abnormal data to be ignored; or adding or updating relation columns in the same table.

In one embodiment, the processor 10 uses missing rules in the data description file according to a preset rule (such as adding blank fields to “0” or calculating an average based on the data of two adjacent fields between the blank field and filling the average value in the blank field) to correct the missing part.

In one embodiment, the processor 10 determines that the field data can be null according to a preset rule, then the processor 10 sets the field data in the field data description to be null. Moreover, subsequent data analysis system will ignore this abnormal data.

In one embodiment, when the processor 10 determines that the field data description file data is abnormal, the processor 10 corrects the field data description file (for example, converts the value into a string), and adds the field data description file (for example, missing data is obtained from the storage device 20 through user input or the processor 10), editing field data description files (for example, changing the value size), ignoring abnormal data, or displaying the field data description file abnormalities through a display.

FIGS. 3A-3B are flowcharts of a field-type analysis method 300 in accordance with one embodiment of the present disclosure. In step 310, the processor 10 obtains one or more data tables. In step 320, the field-type analysis device 30 analyzes the field type.

In one embodiment, the field-type analysis device 30 regards the largest number of data types in a single field as the field type of the field. For example, there are 500 data in a field in the data table, and 499 data are numeric values, then this field type is defined as the numeric field type. For example, if there are 500 data in a field in the data table and 480 data are strings, the field type is defined as the string field type.

In step 330, the field-type analysis device 30 determines whether the field type is a numeric field type. If the field-type analysis device 30 determines that the field type is a numeric field type, then step 340 is performed. If the field-type analysis device 30 determines that the field type is not a numeric field type, step 350 is performed.

In step 340, the field-type analysis device 30 determines whether the field data is an integer or a floating point number. If the field-type analysis device 30 determines that the field data is an integer or a floating point number, step 343 is performed. If the field-type analysis device 30 determines that the field data is not an integer or a floating point number, step 345 is performed.

In one embodiment, integers and floating points are collectively referred to as numeric values.

In step 343, the data type analysis device 30 confirms that the field type in the field data description file is a numeric field type.

In one embodiment, the numeric field types include integers and floating point numbers.

In one embodiment, if the field-type analysis device 30 finds that there is an exception in the field data, it will add a field data description file, edit the field data description file, ignore the abnormal field data or display the abnormality through a display data. For example, if there is some null value in the field data, the null data of the field is ignored.

In step 345, the field-type analysis device 30 corrects the field type to a non-numeric field type.

In an embodiment, when the field-type analysis device 30 further determines that only 0 or 1 is stored in the field data, it is regarded as the Boolean field type. Therefore, the field-type analysis device 30 corrects the field type to be a non-numeric field type. This is just an example, not limited to thereto.

In step 350, the field-type analysis device 30 determines whether the field data includes numeric values. If the field-type analysis device 30 determines that the field data includes numeric values, step 353 is performed. If the field-type analysis device 30 determines that the field data does not include a numerical value, step 355 is performed.

In one embodiment, the field-type analysis device 30 further determines that the string type “12” stored in the field data is considered to include a numeric value, and therefore step 353 is performed. However, this is only an example, and the present invention is not limited thereto.

In step 353, the field-type analysis device 30 corrects the field type in the field data description file to a numeric field type.

In one embodiment, if the field-type analysis device 30 finds that there is an exception in the field data, it will add a field data description file, edit the field data description file, ignore the abnormal field data or display the abnormality through a display data. For example, if there are many null values in the field data (resulting in step 320 determining that the field type is a non-numeric field type), the null field data can be ignored in this field. In this way, the field data description file is modified. If all non-null values in the field data are numeric data, the field type in the field data description file is corrected to the numeric field type.

In step 355, the field-type analysis device 30 determines whether the field data is one of the data types of date, time, or date & time. If the field-type analysis device 30 determines that the field data is one of date, time, or date & time, step 360 is performed. If the field-type analysis device 30 determines that the field data is not one of the data types of date, time, or date & time, step 370 is performed.

In one embodiment, the data types of date, time, or date & time are collectively referred to as time data type.

In step 360, the field-type analysis device 30 corrects the field type in the field data description file to the time field type.

In one embodiment, the field-type analysis device 30 subdivides the time field type. For example, the field-type analysis device 30 subdivides the time field type into time or date. For another example, the field-type analysis device 30 subdivides the time field type into date and time.

In step 370, the field-type analysis device 30 determines whether the field data can be divided into other field types. If the field-type analysis device 30 determines that the field data can be divided into other field types (for example, the field-type analysis device 30 can still analyze that the specific field data accounts for a large proportion), step 380 is performed. If the field data of the field-type analysis device 30 cannot be divided into other field types, the process ends.

In step 380, the field-type analysis device 30 determines whether the field data is text data or Boolean value data. When the field-type analysis device 30 determines that the field data is text data or Boolean value data, the field-type analysis device 30 corrects the field type in the field data description file to a text type or a Boolean type corresponding to the field data.

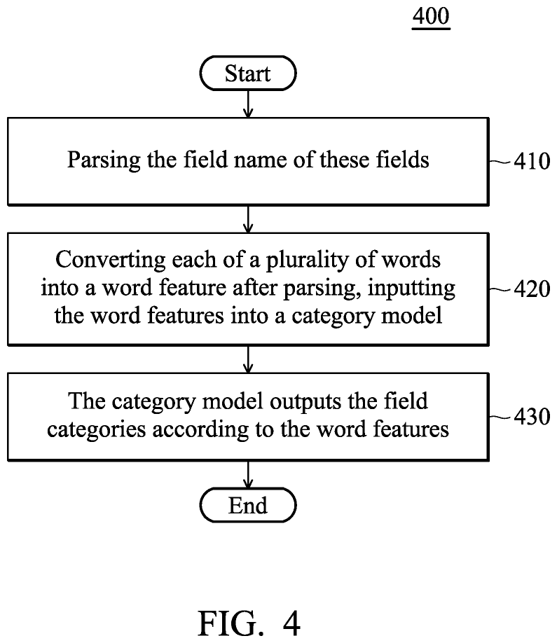

FIG. 4 is a flowchart of a field category method 400 in accordance with one embodiment of the present disclosure. In step 410, the field category device 40 parses the field name of these fields. For example, if the field name in Chinese is “machine number”, then the words will be parsed as “machine” and “number”. For example, if the field name in English is “functionId”, then the word will be parsed as “function” and “Id”. The method of word segmentation in Chinese field names is usually to map the field name to a known corpus. If a matching word is found, the word will be separated. In addition, the parsing method can apply known word parsing algorithms, such as CKIP, HanLP, Ansj, Jieba, etc. to implement. The method of word segmentation for English field names can be to find uppercase/lowercase rules, roots, underlines, blanks, or the naming rules according to field names to separate words.

In step 420, the field category device 40 converts each of a plurality of words into a word feature after parsing, inputs the word features into a category model.

In one embodiment, a pre-built corpus of field category device 40 is compared with all the segmented words. For example, if the word “machine” exists in a pre-built corpus, the field category device 40 marks “machine” as 1. For example, if the word “ice cream” does not exist in the pre-built corpus, the field category device 40 marks “ice cream” as 0. The field category device 40 compares the pre-built corpus with all the segmented words, and there will be many word features composed of 0 and 1.

In one embodiment, the word features may be feature vectors, feature matrices, or a sequence of numeric values. The field category device 40 inputs these word features into a category model. The category model is, for example, a decision tree model. Decision tree models are often used in decision analysis to help determine a strategy that is most likely to achieve the goal. The decision tree can be used as a descriptive means to calculate the conditional probability. In other words, the decision tree can analyze the category of the most likely field according to the characteristics of the words. The decision tree model is a known technique, so it will not be further described here.

In step 430, the category model outputs the field categories according to the word features. In one embodiment, the field category can be, for example, human, machine, material, method, measurement, or others. However, this is only an example, and the present invention is not limited thereto.

For example, if the word feature corresponding to “machine” is input into the decision tree model, the decision tree model will map “machine” to the field category of machine.

For example, if the word feature corresponding to “centimeter” is input into the decision tree model, the decision tree model will map “centimeter” to the field category of the measurement.

In one embodiment, the field category device 40 applies the Decision Tree algorithm, Bayes Category algorithm, k-Nearest Neighbors algorithm, and Support Vector Machine algorithm to determine the field category of each field.

In this way, the field category device 40 can apply the field category method 400 to analyze the field category according to the table and the field name.

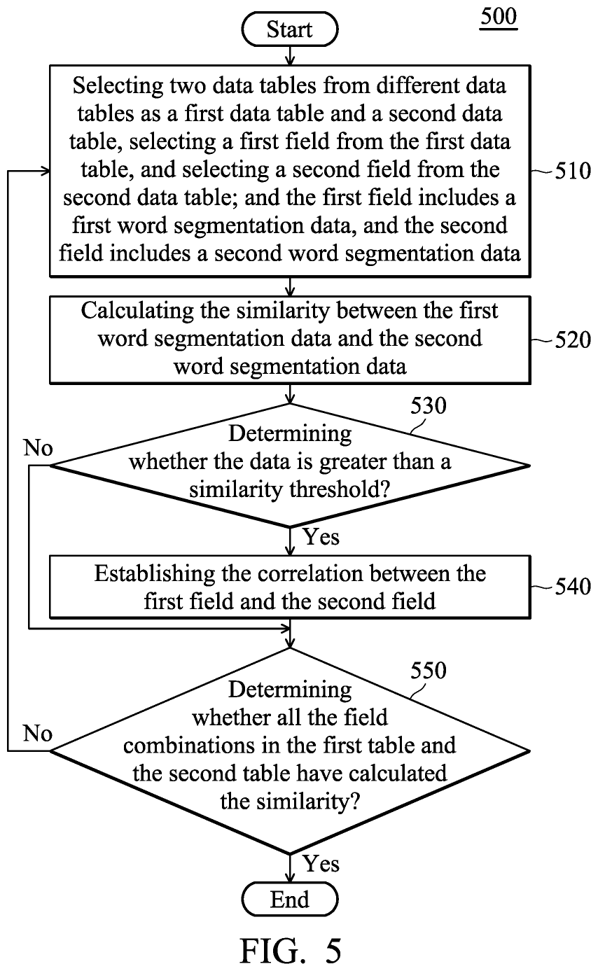

FIG. 5 is a flowchart of a field correlation method 500 in accordance with one embodiment of the present disclosure. In one embodiment, the processor 10 obtains a plurality of data tables.

In step 510, the field correlation device 50 selects two data tables from different data tables as a first data table and a second data table, selects a first field from the first data table, and selects a second field from the second data table; and the first field includes a first word segmentation data, and the second field includes a second word segmentation data.

In one embodiment, the field correlation device 50 segments the field data in the first field and segments the field data the second field, to obtain the first word segmentation data and the second word segmentation data.

In one embodiment, the language of first word segmentation data and the second word segmentation data are the same. For example, in the Chinese, the first word segmentation data is “mechanical”, and the second word segmentation data is “machine”. For example, in the English, the first word segmentation data is “wire”, and the second word segmentation data is “wireless”.

In step 520, the field correlation device 50 calculates the similarity between the first word segmentation data and the second word segmentation data. In one embodiment, the minimum edit distance is selected, and the similarity is calculated according to the minimum edit distance. However, the present invention is not limited to thereto.

In one embodiment, the field correlation device 50 uses the minimum edit distance as the similarity implementation method. The minimum edit distance refers to the number of different words of the first word segmentation data and the second word segmentation. For example, in the Chinese, when the first word segmentation data is “chi-hsieh”(means “mechanical”) and the second word segmentation data is “chi-tai” (means “machine”), the number of words that differ between the two is 1, and the minimum edit distance is regarded as 1. For example, in the English, when the first word segmentation data is “wire” and the second word segmentation data is “wireless”, the number of words (the number of English letters) different between the two is 4, and the minimum edit distance is regarded as 4.

In one embodiment, the field correlation device 50 calculates the similarity based on the minimum edit distance. For example, in the aforementioned Chinese, the longest word has two Chinese characters. In other words, the longest string is 2, using 2 as the denominator, and the longest string minus the minimum editing distance (2−1=1) as the numerator, so the similarity is 1/2 (that is, 50%).

For the example in the Chinese, when the first word segmentation data is “pien-hao” (means “number”) and the second word segmentation data is “pien-hao” (means “number”), the longest word has two Chinese characters. In other words, the longest string is 2, with 2 as the denominator, and the number of different words between the two is 0. The longest string minus the minimum edit distance (2−0=2) is used as the numerator, so the similarity is 2/2 (i.e. 100%).

For example, in the aforementioned English example, the longest word has eight English letters. In other words, the longest string is 8, with 8 as the denominator, and the longest string minus the minimum editing distance (8−4=4) as the numerator, so the similarity is 4/8 (50%).

In step 530, the field correlation device 50 determines whether the data is greater than a similarity threshold. When the field correlation device 50 determines that the similarity is not greater than the similarity threshold, step 550 is performed. When the field correlation device 50 determines that the similarity is greater than the similarity threshold, step 540 is performed.

For example, the similarity threshold can be preset to 80%, and its intention is to represent that when the similarity is greater than 80%, the two fields are considered to be related. In the foregoing example, when the first word segmentation data is “pien-hao” (means “number”) and the second word segmentation data is “pien-hao” (means “number”), the similarity is 100%, and the similarity 100% is greater than the similarity threshold of 80%. It means there is a correlation between the first field and the second field.

In one embodiment, the field category device 40 calculates Euclidean Distance, Manhattan Distance, Hamming Distance, Minkowski distance, Cosine Similarity, Jaccard Similarity, Edit Distance or Pearson Correlation Coefficient based on first word segmentation data and second word segmentation data to generate similarity.

In step 540, the field correlation device 50 establishes the correlation between the first field and the second field. In one embodiment, for example, a flag may be added to the first field and the second field, or the correlation may be recorded in a file.

In this way, the first field can be associated with the second field to facilitate subsequent use. For example, the parameters of a specific experiment are recorded in the first field, and the results of a specific experiment are recorded in the second field. By establishing the correlation between the first field and the second field, the parameter with the result can be associated. In other words, establishing the correlation helps to centralize related fields in complex and huge data tables and field data. It can also be used for other applications in terms of data characteristics.

In step 550, the field correlation device 50 determines whether all the field combinations in the first table and the second table have calculated the similarity. If the field correlation device 50 determines that all the field combinations in the first table and the second table have calculated the similarity, the process ends. If the field correlation device 50 determines that all the field combinations in the first data table and the second data table have not calculated the data similarity, it returns to step 510.

In one embodiment, the processor 10 or the user selects data from database of a department within the enterprise as the data source, a total of 2 different data tables, 30 fields, nearly 36,000 data records (one field may include multiple data records), the data needs to be cleaned and merged for subsequent analysis and use. This experiment designed an experimental group and a control group. The experimental group uses the data analysis system 100 in this case for data analysis. The control group invites experts in the field to check the field category, field type and field correlation by manual process. The evaluation standard is the time it takes to evaluate each item. The experimental results are shown in Table 1 below:

TABLE 1

| | testing type | |
|---|---|---|
| item | control group | experimental group |
| analysis | Experts in the field manually | It took 15 seconds by applying |
| field | check the content of the field | the data analysis method and |
| type | data and determine the data | data analysis system of the |
| | type of the field, which takes | present invention. |
| | 198 seconds. | |
| analysis | Experts in the field manually | Using the data analysis method |
| field | mark the fields. Each field | and data analysis system |
| cate- | takes about 10 to 15 seconds | proposed by the present |
| gory | to determine the type of field. | invention, it took 0.3 seconds |
| | It total takes 30 to 450 | and the accuracy rate reached |
| | seconds to mark 30 fields. | 95.3% (to confirm the accuracy |
| | | of the automatic analysis, the |
| | | field category judged |
| | | automatically is compared with |
| | | the field category judged |
| | | manually, and the accuracy |
| | | rate obtained.). |
| analysis | Experts in the field manually | Using the data analysis method |
| field | determine whether there is a | and data analysis system |
| corre- | correlation between fields in | proposed by the present |
| lation | multiple data tables, which | invention, the comparison |
| | takes 165 seconds in total. | between every two fields takes |
| | | 0.2 seconds. |

In the performance of the three items, the time spent by the experimental group is much better than the control group. Therefore, the data analysis method and the data analysis system proposed by the present invention aim at a large amount of data, improve the efficiency of data analysis, and can analyze huge amounts of complicated data in real time.

According to the data analysis method and data analysis system proposed by the present invention, it is possible to automatically establish an automated mechanism by analyzing information such as field type, field category, correlation, etc. at the stage of data pre-processing. In this way, the data description file of the field is generated to assist the user to quickly understand the data. The data analysis method and data analysis system can reduce the manpower required in the data pre-processing stage and improve the data analysis efficiency in the data pre-processing stage.

The method and algorithm steps disclosed in the specification of the present invention can be directly applied to hardware and software modules or a combination of both by executing a processor. A software module (including execution instructions and related data) and other data can be stored in data memory, such as random access memory (RAM), flash memory (flash memory), read-only memory (ROM), Erasable and programmable read-only memory (EPROM), electronically erasable and programmable read-only memory (EEPROM), registers, hard drives, portable hard drives, CD-ROM, DVD, or any other computer-readable storage media format in this field. A storage medium can be coupled to a machine device, for example, like a computer/processor (for the convenience of description, it is represented by a processor in this manual), the above processor can read information (like a program Code), and write information to storage media. A storage medium can integrate a processor. An application specific integrated circuit (ASIC) includes a processor and a storage medium. User equipment includes a special application integrated circuit. In other words, the processor and the storage medium are included in the user equipment in a manner that does not directly connect to the user equipment. In addition, in some embodiments, any product suitable for a computer program includes a readable storage medium, where the readable storage medium includes code related to one or more disclosed embodiments. In some embodiments, the computer program product may include packaging materials.

The above paragraphs use multiple levels of description. Obviously, the teachings in this invention can be implemented in many ways, and any specific architecture or function disclosed in the example is only a representative situation. According to the teaching of this article, anyone who is familiar with this skill should understand that each level disclosed in this article can be implemented independently or two or more levels can be implemented in combination.

Although the invention has been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such a feature may be combined with one or more other features of the other implementations as may be desired and advantageous for any given or particular application.

What is claimed is:

1. A data analysis system, comprising:
a processor, configured to obtain at least one data table, wherein the data table includes a plurality of fields, and each of the fields stores field data;
a storage device, configured to store the data table;
a field-type analysis device, configured to analyze field type based on the field data;
a field category device, configured to determine a field category for each of the fields; and
a field correlation device, configured to calculate a similarity between the fields in different tables, and determine a correlation between each of the fields according to the similarity;
wherein, a processor generates a field data description file according to the field type, the field categories and the correlations, and the processor determines whether the field data description file is abnormal.

2. The data analysis system of claim 1, wherein when the processor generates the field data description file and determines whether the field data description file is abnormal, an abnormality is displayed through a display.

3. The data analysis system of claim 1, wherein the field data description file is determined to be abnormal when the field data description file is incomplete or when there is an error in the field data description file.

4. The data analysis system of claim 1, wherein when the processor determines that the field data description file is abnormal, the processor automatically corrects the content of the field data description file.

5. The data analysis system of claim 1, wherein the processor is further configured to perform an automatic correction, and the automatic correction comprises: adding or updating a field data description, adding or updating a field data groups, adding or updating the fields to allow nullification, addition, or updating of a field-data value range, allowing abnormal data to be ignored, or adding or updating a relation column in the same table.

6. The data analysis system of claim 5, wherein if the field-type analysis device determines that the field data is not numeric, the field-type analysis device determines whether the field data is a plurality of time data, and if the field-type analysis device determines that the field data is the time data, then the field type in the field data description file is modified to the time field type.

7. The data analysis system of claim 6, wherein if the field-type analysis device determines that the field data is not the time data, the field-type analysis device determines whether the field data is text data or Boolean data, if the field-type analysis device determines that the field data is the text data or the Boolean data, the field-type analysis device corrects the field type in the field data description file to a text type or a Boolean type corresponding to the field data.

8. The data analysis system of claim 7, wherein the field correlation device calculates Euclidean Distance, Manhattan Distance, Hamming Distance, Minkowski distance, Cosine Similarity, Jaccard Similarity, Edit Distance, or Pearson Correlation Coefficient according to the first segmentation data and second segmentation data to generate the similarity.

9. The data analysis system of claim 7, wherein the field category device applies the Decision Tree algorithm, Bayes Category algorithm, k-Nearest Neighbors algorithm, or Support Vector Machine algorithm to determine the field category of the respective fields.

10. The data analysis system of claim 1, wherein the field-type analysis device determines whether the field type is a numeric field type, and if the field-type analysis device determines that the field type is the numeric field type, the field-type analysis device determines whether the field data is numeric, if the field-type analysis device determines that the field data is numeric, the field-type analysis device confirms that the field type in the field data description file is the numeric field type, if the field-type analysis device determines that the field data is not numeric, the field-type analysis device corrects the field type to a non-numeric field type.

11. The data analysis system of claim 1, wherein the field-type analysis device determines whether the field type is a numeric field type, and if the field-type analysis device determines that the field type is not the numeric field type, the field-type analysis device determines whether the field data is numeric, if the field-type analysis device determines that the field data is numeric, then the field-type analysis device corrects the field type in the field data description file to the numeric field type.

12. The data analysis system of claim 1, wherein the field category device parses each one of the field data, converts each of a plurality of words into a word feature after parsing, inputs the word features into a category model; wherein the category model outputs the field categories according to the word features.

13. The data analysis system of claim 1, wherein the processor obtains a plurality of data tables, the field correlation device selects two data tables from different data tables as a first data table and a second data table; and selects a first field from the first data table, selects a second field from the second data table; wherein the first field includes a first word segmentation data, and the second field includes a second word segmentation data, and the field correlation device generates a similarity between the first word segmentation data and the second word segmentation data; when the field correlation device determines that the similarity is greater than a similarity threshold, the correlation between the first field and the second field is established.

14. The data analysis system of claim 13, wherein the field correlation device calculates a minimum edit distance between the first word segmentation data and the second word segmentation data to generate the similarity.

15. A data analysis method, comprising steps of:
obtaining at least one data table; wherein the data table includes a plurality of fields, and each of the fields stores field data;
analyzing field type according to the field data;
determining a field category for each of the fields; and
calculating a similarity between the fields in different tables, and determining a correlation between each of the fields according to the similarity;
generating a field data description file according to the field type, the field categories and the correlations, and determining whether the field data description file is abnormal.

16. The data analysis method of claim 15, wherein the field data description file is determined to be abnormal when the field data description file is incomplete or when there is an error in the field data description file.

17. The data analysis method of claim 15, comprising steps of:
obtains a plurality of data tables and selecting two data tables from different data tables as a first data table and a second data table;
selecting a first field from the first data table and selecting a second field from the second data table; wherein the first field includes a first word segmentation data, and the second field includes a second word segmentation data; and
generating a similarity between the first word segmentation data and the second word segmentation data;
wherein when the similarity is determined to be greater than a similarity threshold, the correlation between the first field and the second field is established.

18. The data analysis method of claim 17, wherein the step of generating a similarity is performed by calculating a minimum edit distance between the first word segmentation data and the second word segmentation data.

19. The data analysis method of claim 15, wherein the step of determining a field category for each of the fields is preformed by Decision Tree algorithm, Bayes Category algorithm, k-Nearest Neighbors algorithm, or Support Vector Machine algorithm.

20. The data analysis method of claim 15, wherein the step of calculating a similarity is performed by calculating Euclidean Distance, Manhattan Distance, Hamming Distance, Minkowski distance, Cosine Similarity, Jaccard Similarity, Edit Distance, or Pearson Correlation Coefficient according to the first segmentation data and second segmentation data.
